(19) United States
(12) Patent Application Publication
(10) Pub. No.: US 2016/0113066 A1
(43) Pub. Date: Apr. 21, 2016

(54) Heating Device for Spray Bottles

(71) Applicant: Shadonna Bethel, Richmond, VA (US)

(72) Inventor: Shadonna Bethel, Richmond, VA (US)

(21) Appl. No.: 14/830,209

(22) Filed: Aug. 19, 2015

Related U.S. Application Data
(60) Provisional application No. 62/065,878, filed on Oct. 20, 2014.

(51) Int. Cl. H05B 3/68; H05B 3/06

(52) U.S. Cl. CPC H05B 3/68; H05B 3/06

(57) ABSTRACT

A heating device for use in warming the contents of spray bottles. The heating device includes a housing having at least one heating plate on the upper surface thereof. The heating plate includes an electrically operated heating element. The heating plate is controlled by the user via a dial that allows a user to select the temperature of the heating plate. The base of a spray bottle can be positioned directly on the surface of a heating plate so that heat from the heating plate is transferred to the spray bottle in order to warm the contents thereof. The spray bottle is preferably composed of a heat resistant material so that the spray bottle will not degrade or melt upon heating. The housing of the heating device may include one or more storage compartments therein for use in storing various items therein.

### CROSS REFERENCE TO RELATED APPLICATION

This application claims the benefit of U.S. Provisional Application No. 62/065,878 filed on Oct. 20, 2014. The above identified patent application is herein incorporated by reference in its entirety to provide continuity of disclosure.

### BACKGROUND OF THE INVENTION

### Field of the Invention

The present invention relates to heating devices. More specifically, the present invention provides a heating device for warming the contents of a spray bottle. The heating device comprises a housing having at least one heating plate thereon, wherein the heating plate is electrically heated and the temperature thereof is controllable via a dial disposed on the housing. The heating device is adapted to warm the base of a spray bottle placed thereon in order to heat the contents of the spray bottle.

Hairdressers, hairstylists, and barbers often spray water onto a client's hair in order to dampen or wet the client's hair. Hairstylists may find it easier to work with hair that is wet in that the hair can be easier to brush, comb, or cut with scissors. However, many clients find the water in spray bottles to be uncomfortably cold. As a result, the client may have a negative experience or may not feel relaxed as the result of being sprayed with the cold water. Some hairstylists may occasionally refill the spray bottle with warm water, but the water does not remain warm and cools over time. Thus, a heating device for warming the liquid within a spray bottle is desired.

Devices have been disclosed in the prior art that relate to heating devices. These include devices that have been patented and published in patent application publications. These devices generally relate to heating devices for bottles or containers, such as U.S. Pat. No. 8,344,290, U.S. Pat. No. 5,786,573, U.S. Pat. No. 5,700,991, U.S. Pat. No. 2,700,097, and U.S. Pat. No. 4,011,992.

These prior art devices have several known drawbacks. The devices in the prior art provide various heating devices for liquids and other substances stored within bottles or containers. However, some devices relate to containers having heating elements integrated therein, and such devices are not suitable for use with conventional bottles or containers. Others devices provide heating devices removably securable to bottles or containers, however, such devices may not be the appropriate size or shape to fit a variety of bottles or containers. Thus, a heating device for use in warming the contents of any sized spray bottle is desired.

In light of the devices disclosed in the prior art, it is submitted that the present invention substantially diverges in design elements from the prior art and consequently it is clear that there is a need in the art for an improvement to existing heating devices. In this regard the instant invention substantially fulfills these needs.

### SUMMARY OF THE INVENTION

In view of the foregoing disadvantages inherent in the known types of heating devices now present in the prior art, the present invention provides a new heating device wherein the same can be utilized for providing convenience for the user when heating the contents of a spray bottle.

It is therefore an object of the present invention to provide a new and improved heating device comprising a housing having at least one heating plate thereon, wherein a spray bottle or similar object is adapted to be positioned directly on the heating plate in order to warm the contents thereof.

It is another object of the present invention to provide a heating device comprising a housing having at least one heating plate thereon, wherein the heating plates include an electric heating element.

Another object of the present invention is to provide a heating device comprising a housing having at least one heating plate thereon, wherein each heating plate is controlled via one or more dials that allow the user to select the temperature of the heating plate.

Another object of the present invention is to provide a heating device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the heating device as used to heat a spray bottle.

FIG. 2 shows a cross sectional view of the heating device.

FIG. 3 shows a perspective view of an end of the heating device having a storage compartment thereon.

### DETAILED DESCRIPTION OF THE INVENTION

Reference is made herein to the attached drawings. Like reference numerals are used throughout the drawings to depict like or similar elements of the heating device. For the purposes of presenting a brief and clear description of the present invention, the preferred embodiment will be discussed as used for heating the contents of a spray bottle. The figures are intended for representative purposes only and should not be considered to be limiting in any respect.

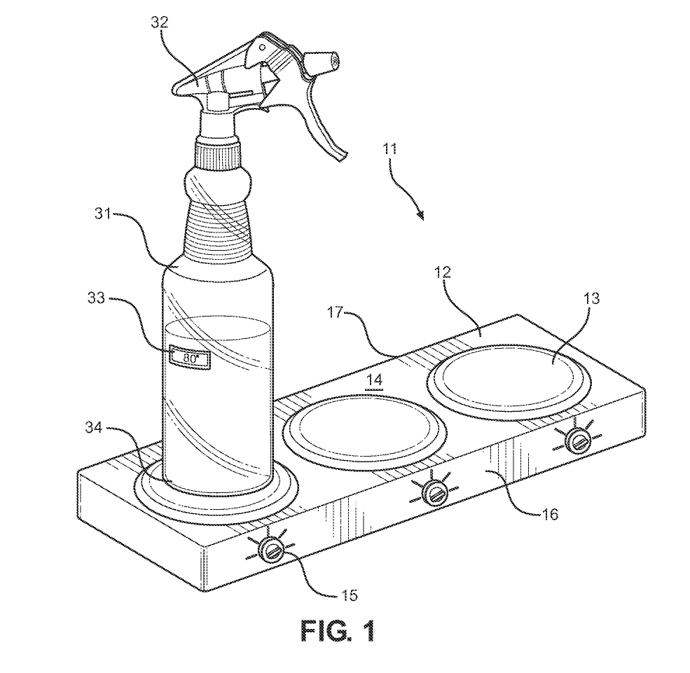

Referring now to FIG. 1, there is shown a perspective view of the heating device as used to heat a spray bottle. The heating device 11 comprises a housing 12 having at least one heating plate 13 thereon. In the illustrated embodiment, the housing 12 comprises a rectangular configuration, however, in alternate embodiments, the housing 12 may have any of various shapes or configurations. The housing 12 includes a planar upper surface 14 such that the surface of each heating plate 13 thereon is also substantially planar. In this way, a spray bottle or similar container can be stably positioned on the heating plate 13.

In the illustrated embodiment, three heating plates 13 are shown wherein the heating plates 13 are arranged in a linear or side-by-side orientation. However, in alternate embodiments, the housing 12 may include fewer or additional heating plates 13. The heating plates 13 preferably comprise a circular configuration so as to be shaped similarly to the cross sectional area of a spray bottle. A spray bottle or similar object can be placed directly on each heating plate 13 for heating.

The heating plates 13 include an electrical heating element therein. The electrical heating element produces heat when electrical current passes therethrough. Each heating plate 13 comprises a dial 15 or other similar control for allowing the user to select the temperature of the corresponding heating plate 13. The housing 12 includes a front end 16 and a rear end 17, wherein the dials 15 are located on the front end 16 thereof so that the dials 15 are easily accessible. In this way, the user can increase or decrease the temperature of the heating plate 13 in order to warm the contents of a spray bottle 31 to a desired extent.

In some embodiments, a spray bottle 31 specially adapted for use with the heating device 11 is provided. The spray bottle 31 comprises a container having a hollow interior volume in which liquid can be stored. The container comprises an open upper end, wherein said open upper end removably receives a cap having a spray nozzle 32 thereon. The spray nozzle 32 is adapted to disperse the contents of the container in a fine mist or stream. The spray bottle 31 is preferably composed of a heat-resistant material that will not deform or melt upon exposure to heat. The spray bottle 31 may include a temperature sensor 33 thereon in order to both determine and display the temperature of the contents thereof. Further, in some embodiments, the spray bottle 31 includes a magnetic base 34 that is adapted to be magnetically secured to the heating plate so that the spray bottle 31 is secured to the heating device 11.

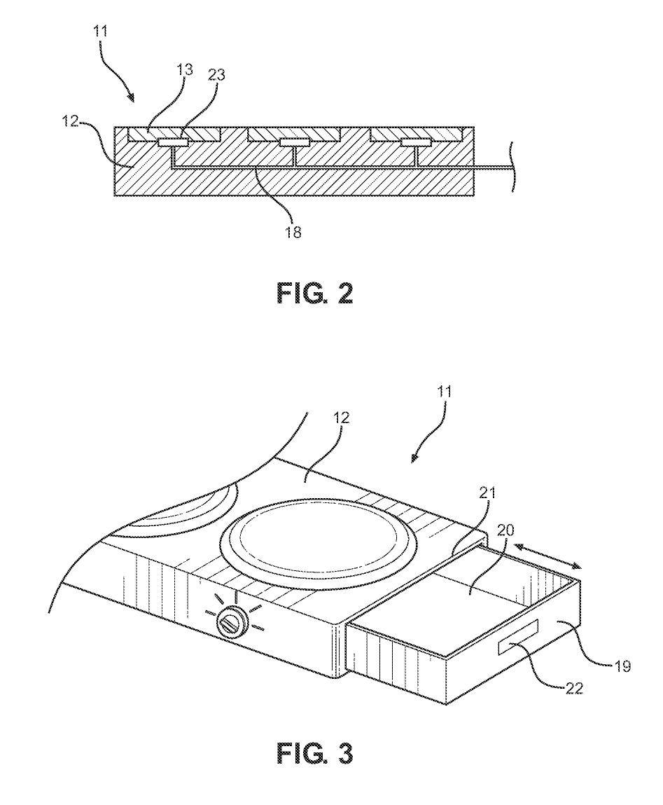

Referring now to FIG. 2, there is shown a cross sectional view of the heating device. The housing 12 comprises at least one heating plate 13, wherein each heating plate 13 includes an electric heating element 23. Each electric heating element 23 is electrically connected via a control circuit 18. The control circuit 18 distributes electricity to the heating elements 13 from a power source, and the control circuit 18 further connects the heating elements to the corresponding dial for controlling the operation of the heating plate 13. The control circuit 18 may further include means for preventing the heating plates 13 from reaching a predetermined temperature maximum in order to prevent the heating plates 13 from overheating.

Referring now to FIG. 3, there is shown a perspective view of an end of the heating device having a storage container thereon. The housing 12 of the heating device 11 further includes one or more storage containers 19. In the illustrated embodiment, the heating device 11 includes a storage container 19 resembling a drawer that is slidably positioned within an end 21 of the housing 12. The storage container 19 can be extended from or retracted into the housing 12 as desired by the user. The storage container 19 includes an interior volume 20 in which any of various tools and items can be positioned for storage. Further, the storage container 19 includes a handle 22 thereon for allowing the user to easily grasp the storage container 19 in order to move the storage container 19 between stored and extended configurations. In the extended configuration, the user may place a cup or jar on the storage container 19 for use in storing hairstyling tools in an upright orientation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A heating device for spray bottles, comprising:
a housing having at least one heating plate thereon, wherein said at least one heating plate is adapted to heat a spray bottle placed thereon;
wherein each of said at least one heating plate comprises an electric heating element;
wherein each of said at least one heating plate is controllable via a dial electrically connected thereto, wherein said dial controls the temperature of said at least one heating plate;
wherein said housing further includes one or more storage containers therein.

2) The heating device of claim 1, wherein said housing comprises a planar upper surface.

3) The heating device of claim 1, wherein said at least one heating plate comprises a circular configuration.

4) The heating device of claim 1, wherein said one or more storage containers resemble a drawer, wherein said one or more storage containers is slidably positioned within an end of said housing such that it is movable between an extended and a retracted configuration.

5) The heating device of claim 1, wherein said at least one heating plate is adapted to receive a base of a spray bottle thereon.

6) The heating device of claim 1, further comprising a spray bottle comprising a container having a hollow interior volume, wherein said container includes a spray nozzle thereon, and wherein said spray bottle comprises a base adapted for placement on said at least one heating plate.

7) The heating device of claim 6, wherein said spray bottle further comprises a temperature sensor thereon.

8) The heating device of claim 6, wherein said spray bottle comprises a magnetic base.
